(19) United States
(12) Patent Application Publication
(10) Pub. No.: US 2025/0074449 A1
(43) Pub. Date: Mar. 6, 2025

(54) ALERTING VEHICLE OCCUPANTS OF AUTOMATED VEHICLE ACTIONS

(71) Applicant: GM Global Technology Operations LLC, Detroit, MI (US)

(72) Inventors: Akilesh Rajavenkatanarayanan, Macomb, MI (US); Manoj Kumar Sharma, Troy, MI (US); Claudia Goldman-Shenhar, Mevasseret Zion (IL); Joseph F. Szczerba, Grand Blanc, MI (US)

(21) Appl. No.: 18/457,750

(22) Filed: Aug. 29, 2023

(51) Int. Cl. B60W 50/16; B60W 60/00

(52) U.S. Cl. CPC B60W 50/16; B60W 60/001; B60K 35/00; B60K 35/23; B60K 35/28; B60K 2360/175; B60K 2360/177; B60W 30/18163; B60W 2050/146; B60W 2540/225; B60W 2555/60; B60W 2720/106; G09F 9/00

(57) ABSTRACT

A system for providing information to a vehicle occupant of a vehicle includes an automated driving system, a first display configured to provide information to the vehicle occupant of the vehicle, and a controller in electrical communication with the automated driving system and the first display. The controller is programmed to identify a planned change in driving behavior initiated by the automated driving system. The controller is further programmed to identify a traffic sign interpretation error using the automated driving system. The controller is further programmed to notify the vehicle occupant using the first display in response to identifying at least one of: the planned change in driving behavior and the traffic sign interpretation error.

### INTRODUCTION

The present disclosure relates to an augmented reality head-up display for displaying information to an occupant of a vehicle.

Augmented reality (AR) involves enhancing the real world with virtual elements that are shown in three-dimensional space and that permit real-time interaction with users. A head-up display (HUD) shows information such as, for example, vehicle speed and navigational instructions, directly onto a windscreen of a vehicle, within the occupant's forward field of view. Accordingly, the head-up display provides occupants with information without looking away from the road. One possible implementation for augmented reality is an augmented reality head-up display (AR-HUD) for a vehicle. By overlaying images on the windscreen, AR-HUDs enhance an occupant's view of the environment outside the vehicle, creating a greater sense of environmental awareness. However, current AR-HUDs may not provide additional information about the operation of vehicle systems and components to occupants.

Therefore, while current augmented reality head-up displays achieve their intended purpose, there is a need in the art for an improved approach for providing information to vehicle occupants.

### SUMMARY

According to several aspects, a system for providing information to a vehicle occupant of a vehicle is provided. The system may include an automated driving system, a first display configured to provide information to the vehicle occupant of the vehicle, and a controller in electrical communication with the automated driving system and the first display. The controller is programmed to identify a planned change in driving behavior initiated by the automated driving system. The controller is further programmed to identify a traffic sign interpretation error using the automated driving system. The controller is further programmed to notify the vehicle occupant using the first display in response to identifying at least one of: the planned change in driving behavior and the traffic sign interpretation error.

In another aspect of the present disclosure, to identify the planned change in driving behavior, the controller is further programmed to monitor a path planning algorithm of the automated driving system for the planned change in driving behavior. The planned change in driving behavior includes at least one of: a sudden stop, a sudden acceleration, a lane change, and a lane merge.

In another aspect of the present disclosure, the system further includes a plurality of vehicle sensors in electrical communication with the controller. To identify the traffic sign interpretation error, the controller is further programmed to detect a traffic sign of interest using the plurality of vehicle sensors. To identify the traffic sign interpretation error, the controller is further programmed to search a database of known traffic signs for the traffic sign of interest. To identify the traffic sign interpretation error, the controller is further programmed to identify the traffic sign interpretation error in response to determining that the traffic sign of interest is not found within the database of known traffic signs.

In another aspect of the present disclosure, to notify the vehicle occupant, the controller is further programmed to generate a graphic based at least in part on at least one of: the planned change in driving behavior and the traffic sign interpretation error. To notify the vehicle occupant, the controller is further programmed to display the graphic to the vehicle occupant using the first display.

In another aspect of the present disclosure, to generate the graphic, the controller is further programmed to generate a warning graphic in response to identifying the planned change in driving behavior. The warning graphic is configured to warn the vehicle occupant of the planned change in driving behavior. To generate the graphic, the controller is further programmed to generate a confirmation graphic in response to identifying the traffic sign interpretation error. The confirmation graphic is configured to prompt the vehicle occupant to resolve the traffic sign interpretation error.

In another aspect of the present disclosure, to generate the warning graphic, the controller is further programmed to determine an explanation for the planned change in driving behavior using an explainable artificial intelligence (XAI) algorithm. To generate the warning graphic, the controller is further programmed to identify an object of interest in an environment surrounding the vehicle which caused the automated driving system to initiate the planned change in driving behavior based at least in part on the explanation. To generate the warning graphic, the controller is further programmed to generate the warning graphic. The warning graphic appears overlayed on the object of interest from a perspective of the vehicle occupant.

In another aspect of the present disclosure, the first display is an augmented reality head-up display (AR-HUD) system in electrical communication with the controller. The AR-HUD system includes an occupant position tracking device and an AR-HUD projector. To display the graphic, the controller is further programmed to determine a position of the vehicle occupant of the vehicle using the occupant position tracking device. To display the graphic, the controller is further programmed to calculate a size, shape, and location of the graphic based on the position of the vehicle occupant. To display the graphic, the controller is further programmed to display the graphic on a front windscreen of the vehicle using the augmented reality head up display system based on the size, shape, and location.

In another aspect of the present disclosure, the first display further includes a transparent front windscreen display (TWD) system in electrical communication with the controller. The transparent front windscreen display system includes transparent phosphors embedded in the front windscreen of the vehicle and a TWD projector. To display the graphic, the controller is further programmed to calculate a size, shape, and location of the graphic. To display the graphic, the controller is further programmed to display the graphic on the front windscreen of the vehicle using the TWD system based on the size, shape, and location.

In another aspect of the present disclosure, the system further includes a second display in electrical communication with the controller. The second display is configured to provide information to a remote vehicle occupant. The controller is further programmed to notify the remote vehicle occupant using the second display in response to identifying the planned change in driving behavior.

In another aspect of the present disclosure, the system further includes a haptic feedback device in electrical communication with the controller. The controller is further programmed to notify the vehicle occupant using the haptic feedback device in response to identifying the planned change in driving behavior.

According to several aspects, a method for providing information to a vehicle occupant of a vehicle is provided. The method may include identifying a planned change in driving behavior initiated by an automated driving system. The method further may include identifying a traffic sign interpretation error using the automated driving system. The method further may include determining a notification modality in response to identifying at least one of: the planned change in driving behavior and the traffic sign interpretation error. The notification modality includes one of: a visual notification modality and a haptic notification modality. The method further may include notifying the vehicle occupant using an augmented reality head-up display (AR-HUD) system in response to determining that the notification modality is the visual notification modality. The method further may include notifying the vehicle occupant using a haptic feedback device in response to determining that the notification modality is the haptic notification modality.

In another aspect of the present disclosure, identifying the planned change in driving behavior further may include monitoring a path planning algorithm of the automated driving system for the planned change in driving behavior. The planned change in driving behavior includes at least one of: a sudden stop, a sudden acceleration, a lane change, and a lane merge.

In another aspect of the present disclosure, identifying the traffic sign interpretation error further may include detecting a traffic sign of interest using a plurality of vehicle sensors. Identifying the traffic sign interpretation error further may include searching a database of known traffic signs for the traffic sign of interest. Identifying the traffic sign interpretation error further may include identifying the traffic sign interpretation error in response to determining that the traffic sign of interest is not found within the database of known traffic signs.

In another aspect of the present disclosure, determining the notification modality further may include determining a gaze direction of the vehicle occupant using an occupant position tracking device. The gaze direction includes a front windscreen gaze direction and a non-front windscreen gaze direction. Determining the notification modality further may include determining the notification modality to be the visual notification modality in response to determining that the gaze direction is the front windscreen gaze direction. Determining the notification modality further may include determining the notification modality to be the haptic notification modality in response to determining that the gaze direction is the non-front windscreen gaze direction.

In another aspect of the present disclosure, notifying the vehicle occupant using the AR-HUD system further may include generating a warning graphic in response to identifying the planned change in driving behavior. Generating the warning graphic further may include determining an explanation for the planned change in driving behavior using an explainable artificial intelligence (XAI) algorithm. Generating the warning graphic further may include identifying an object of interest in an environment surrounding the vehicle which caused the automated driving system to initiate the planned change in driving behavior based at least in part on the explanation. Generating the warning graphic further may include generating the warning graphic, where warning graphic appears overlayed on the object of interest from a perspective of the vehicle occupant. Notifying the vehicle occupant using the AR-HUD system further may include generating a confirmation graphic in response to identifying the traffic sign interpretation error. The confirmation graphic is configured to prompt the vehicle occupant to resolve the traffic sign interpretation error.

In another aspect of the present disclosure, notifying the vehicle occupant using the AR-HUD system further may include determining a position of the vehicle occupant of the vehicle using an occupant position tracking device. Notifying the vehicle occupant using the AR-HUD system further may include calculating a size, shape, and location of the warning graphic based on the position of the vehicle occupant. Notifying the vehicle occupant using the AR-HUD system further may include displaying at least one of: the warning graphic and the confirmation graphic on a front windscreen of the vehicle using the AR-HUD system based on the size, shape, and location.

In another aspect of the present disclosure, the method further includes notifying a remote vehicle occupant using a second display in response to identifying the planned change in driving behavior. The second display is configured to provide information to the remote vehicle occupant.

According to several aspects, a system for providing information to a vehicle occupant of a vehicle is provided, the system may include a plurality of vehicle sensors, an automated driving system, a first display configured to provide information to the vehicle occupant of the vehicle, a second display configured to provide information to a remote vehicle occupant of a remote vehicle. The second display is a rear display affixed to a rear windscreen of the vehicle. The system further may include a controller in electrical communication with the plurality of vehicle sensors, the automated driving system, the first display and the second display. The controller is programmed to identify a planned change in driving behavior initiated by the automated driving system. The controller is further programmed to identify a traffic sign interpretation error using the automated driving system. The controller is further programmed to notify the vehicle occupant using the first display in response to identifying at least one of: the planned change in driving behavior and the traffic sign interpretation error. The controller is further programmed to notify the remote vehicle occupant using the second display in response to identifying the planned change in driving behavior.

In another aspect of the present disclosure, to notify the vehicle occupant using the first display, the controller is further programmed to determine an explanation for the planned change in driving behavior using an explainable artificial intelligence (XAI) algorithm. To notify the vehicle occupant using the first display, the controller is further programmed to identify an object of interest in an environment surrounding the vehicle which caused the automated driving system to initiate the planned change in driving behavior based at least in part on the explanation. To notify the vehicle occupant using the first display, the controller is further programmed to generate a warning graphic. The warning graphic indicates the object of interest. To notify the vehicle occupant using the first display, the controller is further programmed to display the warning graphic to the vehicle occupant using the first display.

In another aspect of the present disclosure, the first display is an augmented reality head-up display (AR-HUD) system in electrical communication with the controller. The AR-HUD system includes an occupant position tracking device and an AR-HUD projector. To display the warning graphic, the controller is further programmed to determine a position of the vehicle occupant of the vehicle using the occupant position tracking device. To display the warning graphic, the controller is further programmed to calculate a size, shape, and location of the warning graphic based on the position of the vehicle occupant. To display the warning graphic, the controller is further programmed to display the warning graphic on a front windscreen of the vehicle using the augmented reality head up display system based on the size, shape, and location.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for providing information to a vehicle occupant of a vehicle, according to an exemplary embodiment;

FIG. 2 is a schematic diagram of an AR-HUD system for use by an exemplary occupant, according to an exemplary embodiment;

FIG. 3 is a schematic front view of a dual-focal plane augmented reality display, highlighting a second image plane of the dual-focal plane augmented reality display, according to an exemplary embodiment;

FIG. 4 is a schematic diagram of the second image plane of the dual-focal plane augmented reality display, according to an exemplary embodiment;

FIG. 5 is a schematic diagram of an exemplary use of a rear display, according to an exemplary embodiment;

FIG. 6 is a flowchart of a method for providing information to the vehicle occupant of the vehicle, according to an exemplary embodiment;

FIG. 7 is a schematic diagram of a first view from within the vehicle from a perspective of the vehicle occupant, according to an exemplary embodiment; and

FIG. 8 is a schematic diagram of a second view from within the vehicle from the perspective of the vehicle occupant, according to an exemplary embodiment.

### DETAILED DESCRIPTION

The following description is merely exemplary in nature and is not intended to limit the present disclosure, application, or uses.

Vehicle automated driving systems may evaluate an environment surrounding the vehicle and make adjustments to a planned path in response to changing conditions, such as, for example, movements of remote vehicles. In some cases, vehicle sensors may detect anomalies such as, for example, shadows, glares, reflections, foreign objects on the roadway, water on the roadway, and/or the like. Detection of such anomalies may result in an adjustment to the planned path. Therefore, the present disclosure provides for a new and improved system and method for providing information to a vehicle occupant of a vehicle which informs the vehicle occupant about planned changes in driving behavior, giving the vehicle occupant an opportunity to take action in response to the planned change in driving behavior.

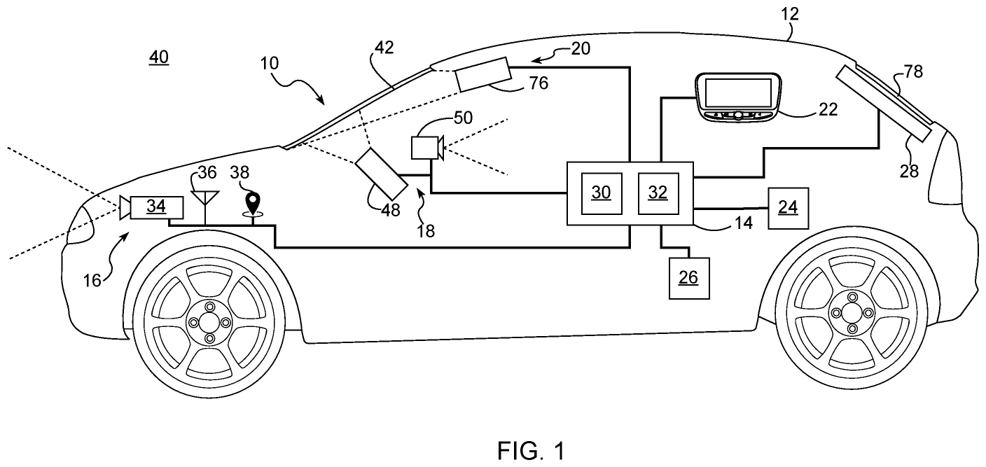

Referring to FIG. 1, a system for providing information to a vehicle occupant of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, a plurality of vehicle sensors 16, an augmented reality head-up display (AR-HUD) system 18, a transparent front windscreen display (TWD) system 20, a human-machine interface (HMI) 22, an automated driving system 24, a haptic feedback device 26, and a rear display 28.

The controller 14 is used to implement a method 100 for providing information to a vehicle occupant of a vehicle, as will be described below. The controller 14 includes at least one processor 30 and a non-transitory computer readable storage device or media 32. The processor 30 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. The computer readable storage device or media 32 may include volatile and nonvolatile storage in read-only memory (ROM), random-access memory (RAM), and keep-alive memory (KAM), for example. KAM is a persistent or non-volatile memory that may be used to store various operating variables while the processor 30 is powered down. The computer-readable storage device or media 32 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12. The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the plurality of vehicle sensors 16, the augmented reality head-up display (AR-HUD) system 18, the transparent front windscreen display (TWD) system 20, the human-machine interface (HMI) 22, the automated driving system 24, the haptic feedback device 26, and the rear display 28. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure.

The plurality of vehicle sensors 16 are used to acquire information relevant to the vehicle 12. In an exemplary embodiment, the plurality of vehicle sensors 16 includes at least a camera system 34, a vehicle communication system 36, and a global navigation satellite system (GNSS) 38.

In another exemplary embodiment, the plurality of vehicle sensors 16 further includes sensors to determine performance data about the vehicle 12. In a non-limiting example, the plurality of vehicle sensors 16 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the plurality of vehicle sensors 16 further includes sensors to determine information about an environment within the vehicle 12. In a non-limiting example, the plurality of vehicle sensors 16 further includes at least one of a seat occupancy sensor, a cabin air temperature sensor, a cabin motion detection sensor, a cabin camera, a cabin microphone, and/or the like.

In another exemplary embodiment, the plurality of vehicle sensors 16 further includes sensors to determine information about an environment 40 surrounding the vehicle 12. In a non-limiting example, the plurality of vehicle sensors 16 further includes at least one of an ambient air temperature sensor, a barometric pressure sensor, and/or a photo and/or video camera which is positioned to view the environment 40 in front of the vehicle 12.

In another exemplary embodiment, at least one of the plurality of vehicle sensors 16 is a perception sensor capable of perceiving objects and/or measuring distances in the environment 40 surrounding the vehicle 12. In a non-limiting example, the plurality of vehicle sensors 16 includes a stereoscopic camera having distance measurement capabilities. In one example, at least one of the plurality of vehicle sensors 16 is affixed inside of the vehicle 12, for example, in a headliner of the vehicle 12, having a view through a front windscreen 42 of the vehicle 12. In another example, at least one of the plurality of vehicle sensors 16 is affixed outside of the vehicle 12, for example, on a roof of the vehicle 12, having a view of the environment 40 surrounding the vehicle 12. It should be understood that various additional types of perception sensors, such as, for example, LiDAR sensors, ultrasonic ranging sensors, radar sensors, and/or time-of-flight sensors are within the scope of the present disclosure. The plurality of vehicle sensors 16 are in electrical communication with the controller 14 as discussed above.

The camera system 34 is a perception sensor used to capture images and/or videos of the environment 40 surrounding the vehicle 12. In an exemplary embodiment, the camera system 34 includes a photo and/or video camera which is positioned to view the environment 40 surrounding the vehicle 12. In a non-limiting example, the camera system 34 includes a camera affixed inside of the vehicle 12, for example, in a headliner of the vehicle 12, having a view through the front windscreen 42. In another non-limiting example, the camera system 34 includes a camera affixed outside of the vehicle 12, for example, on a roof of the vehicle 12, having a view of the environment 40 in front of the vehicle 12.

In another exemplary embodiment, the camera system 34 is a surround view camera system including a plurality of cameras (also known as satellite cameras) arranged to provide a view of the environment 40 adjacent to all sides of the vehicle 12. In a non-limiting example, the camera system 34 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 34 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The GNSS 38 is used to determine a geographical location of the vehicle 12. In an exemplary embodiment, the GNSS 38 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS 38 additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS 38. It should be understood that various additional types of satellite-based radionavigation systems, such as, for example, the Global Positioning System (GPS), Galileo, GLONASS, and the BeiDou Navigation Satellite System (BDS) are within the scope of the present disclosure. It should be understood that the GNSS 38 may be integrated with the controller 14 (e.g., on a same circuit board with the controller 14 or otherwise a part of the controller 14) without departing from the scope of the present disclosure.

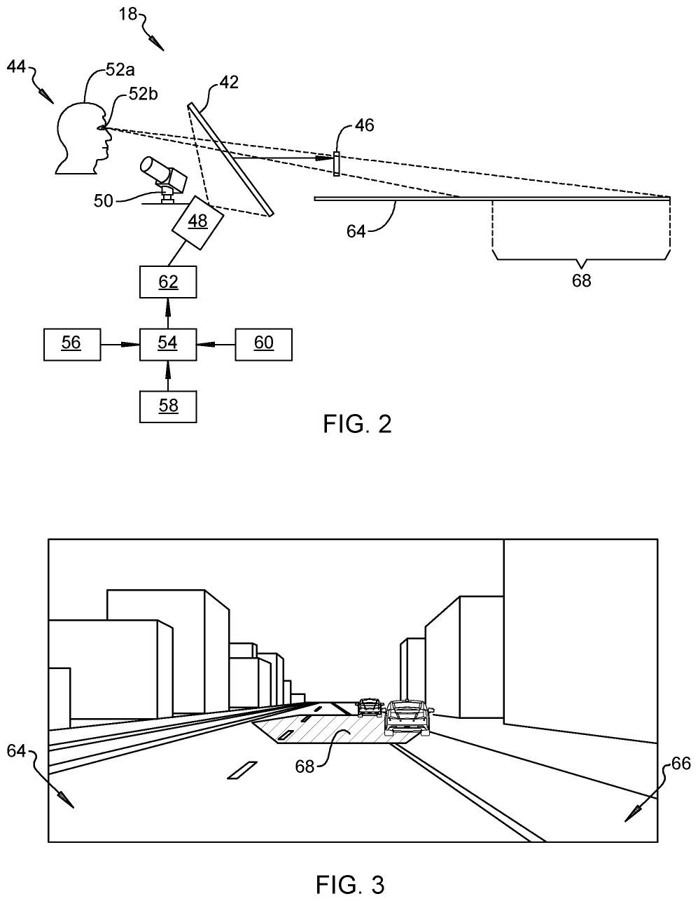

Referring to FIG. 2, a system diagram of the AR-HUD system 18 for use by an exemplary vehicle occupant 44 is shown. In the scope of the present disclosure, the vehicle occupant 44 includes, in a non-limiting example, a driver, a passenger, and/or any additional persons in the vehicle 12. The AR-HUD system 18 is used to display AR-HUD graphics 46 (i.e., notification symbols providing visual information to the vehicle occupant 44) on the front windscreen 42 of the vehicle 12. The AR-HUD system 18 includes an AR-HUD projector 48 and an occupant position tracking device 50. The AR-HUD system 18 is in electrical communication with the controller 14 as discussed above.

The AR-HUD projector 48 is used to project the AR-HUD graphics 46 on the front windscreen 42 of the vehicle 12. It should be understood that various devices designed to project images including, for example, optical collimators, laser projectors, digital light projectors (DLP), and the like are within the scope of the present disclosure.

The occupant position tracking device 50 is used to determine a position of the vehicle occupant 44 in the vehicle 12. For example, the occupant position tracking device 50 may track a position of a head 52a or eyes 52b of the vehicle occupant 44. The position of the vehicle occupant 44 in the vehicle 12 from the occupant position tracking device 50 is used to locate the AR-HUD graphic 46 on the front windscreen 42 of the vehicle 12. In an exemplary embodiment, the occupant position tracking device 50 is one or more cameras disposed in the vehicle 12.

To operate the AR-HUD system 18, the controller 14 includes multiple software modules, including a system manager 54. During operation of the system 18, the system manager 54 receives at least a first input 56, a second input 58, and a third input 60. The first input 56 is indicative of the location of the vehicle 12 in space (i.e., the geographical location of the vehicle 12), the second input 58 is indicative of the vehicle occupant 44 position in the vehicle 12 (e.g., the position of the eyes and/or head of the vehicle occupant 44 in the vehicle 12), and the third input 60 is data pertaining to a planned change in driving behavior and/or a traffic sign interpretation error, as will be discussed in greater detail below. The first input 56 may include data such as GNSS data (e.g., GPS data), vehicle speed, roadway curvature, and vehicle steering, and this data is collected from the plurality of vehicle sensors 16. The second input 58 is received from the occupant position tracking device 50. The third input 60 is data pertaining to a planned change in driving behavior and/or a traffic sign interpretation error. The system manager 54 is configured to determine (e.g., compute) the type, size, shape, and color of the AR-HUD graphics 46 to be displayed using the AR-HUD projector 48 based on the first input 56 (i.e., the vehicle location in the environment 40), the second input 58 (e.g., the position of the eyes 52b and/or head 52a of the vehicle occupant 44 in the vehicle 12), and the third input 60 (i.e. the data pertaining to a planned change in driving behavior and/or a traffic sign interpretation error). The system manager 54 instructs an image engine 62, which is a software module or an integrated circuit of the AR-HUD projector 48 or the controller 14, to display the

AR-HUD graphic 46 using the AR-HUD projector 48. The image engine 62 displays the AR-HUD graphic 46 on the front windscreen 42 of the vehicle 12 using the AR-HUD projector 48 based on the type, size, shape, and color of the AR-HUD graphic 46 determined by the system manager 54. The AR-HUD graphic 46 is projected on the front windscreen 42 by the AR-HUD projector 48 to show the AR-HUD graphic 46 along a roadway surface 64.

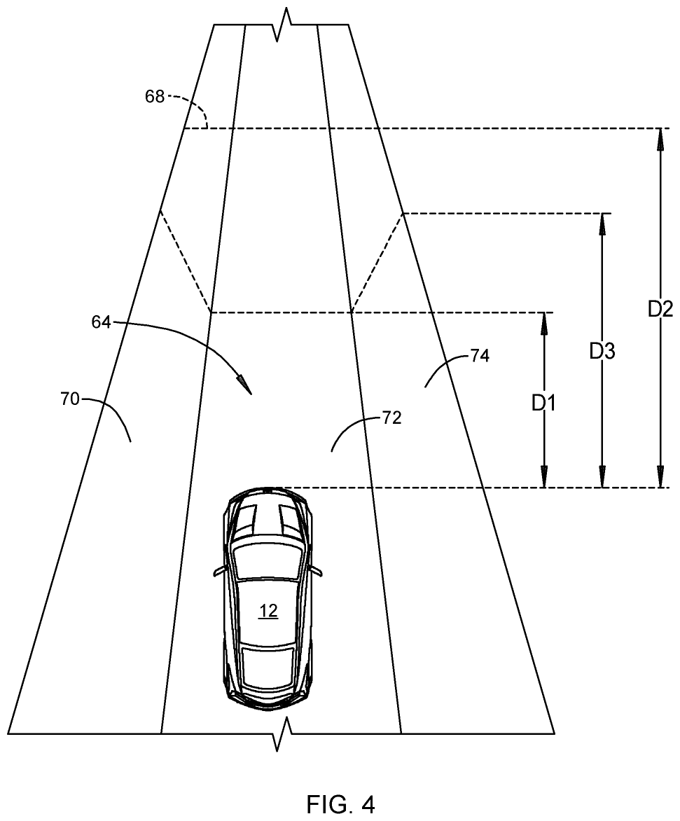

In the exemplary embodiment of the present disclosure, the AR-HUD system 18 is a dual-focal plane AR-HUD system. With reference to FIGS. 3 and 4 and with continued reference to FIG. 2, the AR-HUD system 18 has a first image plane 66 and a second image plane 68. The first image plane 66 shows the view of the outside world, and the second image plane 68 is reserved for displaying the AR-HUD graphics 46. The second image plane 68 spans multiple lanes and the AR-HUD graphics 46 appear at a location farther on a roadway surface 64 relative to the first image plane 66. For instance, as shown in FIGS. 3 and 4, the second image plane 68 covers a left lane 70, a central lane 72, and a right lane 74. As a non-limiting example, in the central lane 72, the second image plane 68 starts at a first predetermined distance D1 (e.g., twenty-five meters) from the vehicle 12 and ends at a second predetermined distance D2 (e.g., ninety meters) from the vehicle 12. Regardless of the specific distances, the second predetermined distance D2 is greater than the first predetermined distance D1 to help the vehicle occupant 44 see the AR-HUD graphics 46 displayed using the AR-HUD projector 48. In the left lane 70 and the right lane 74, the second image plane 68 is delimited by a sloped boundary that starts at the first predetermined distance D1 from the vehicle 12 and ends at a third predetermined distance D3 (e.g., fifty meters) from the vehicle 12. The third predetermined distance D3 is greater than the first predetermined distance D1 and less than the second predetermined distance D2 to help the vehicle occupant 44 see the AR-HUD graphics 46 displayed using the AR-HUD projector 48. As used herein, the term “dual-focal plane AR-HUD” means an AR-HUD system that presents images in a first image plane and a second image plane, wherein the first image plane and the second image plane are at different locations. It is desirable to configure the AR-HUD system 18 as a dual-focal plane AR-HUD to facilitate manipulation of the AR-HUD graphics 46 on the view of the outside world. For instance, by using a dual-focal plane AR-HUD, the size, location, and characteristics of the AR-HUD graphics 46 may be changed based on, for example, the location of the eyes 52b of the vehicle occupant 44.

The TWD system 20 is used to display images on the front windscreen 42 of the vehicle 12. In an exemplary embodiment, the AR-HUD system 18 can display the AR-HUD graphics 46 in a predefined region of the front windscreen 42 (e.g., in the first image plane 66 and the second image plane 68). The TWD system 20 can display TWD graphics (not shown) in any region of the front windscreen 42. Therefore, by operating the AR-HUD system 18 and the TWD system 20 in conjunction, the controller 14 may display graphics in any region of the front windscreen 42. In an exemplary embodiment, the TWD system 20 includes transparent phosphors (not shown) embedded into the front windscreen 42 and a TWD projector 76 (FIG. 1). The TWD system 20 is in electrical communication with the controller 14 as discussed above.

The transparent phosphors are light emitting particles which fluoresce in response to being excited by the TWD projector 76. In an exemplary embodiment, the transparent phosphors are red, green, and blue (RGB) phosphors, allowing full color operation of the TWD system 20. The use of monochrome and/or two-color phosphors is also within the scope of the present disclosure. When excitation light is absorbed by the transparent phosphors, visible light is emitted by the transparent phosphors. The excitation light may be, for example, violet light in the visible spectrum (ranging from about 380 to 450 nanometers) and/or ultraviolet light.

The TWD projector 76 is used to excite the transparent phosphors in a predetermined pattern to produce the TWD graphics on the front windscreen 42. In an exemplary embodiment, the TWD projector 76 is a violet/ultraviolet laser projector disposed proximally to the headliner of the vehicle 12. The TWD projector 76 includes three lasers, each laser configured to excite one of the red, green, or blue transparent phosphors.

In an exemplary embodiment, the HMI 22 is used in addition to the AR-HUD system 18 and the TWD system 20 to display information to the vehicle occupant 44 of the vehicle 12. In another exemplary embodiment, the HMI 22 is used instead of the AR-HUD system 18 and/or the TWD system 20 to display information to the vehicle occupant 44 of the vehicle 12. In the aforementioned exemplary embodiments, the HMI 22 is a display system located in view of the vehicle occupant 44 and capable of displaying text, graphics, and/or images. It is to be understood that HMI display systems including LCD displays, LED displays, and the like are within the scope of the present disclosure. Further exemplary embodiments where the HMI 22 is disposed in a rearview mirror are also within the scope of the present disclosure. The HMI 22 is in electrical communication with the controller 14 as discussed above.

The automated driving system 24 is used to provide assistance to the vehicle occupant 44 to increase occupant awareness and/or control behavior of the vehicle 12. In the scope of the present disclosure, the automated driving system 24 encompasses systems which provide any level of assistance to the vehicle occupant 44 (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 24 is configured to detect and/or receive information about the environment 40 surrounding the vehicle 12 and process the information to provide assistance to the vehicle occupant 44. In some embodiments, the automated driving system 24 is a software module executed on the controller 14. In other embodiments, the automated driving system 24 includes a separate automated driving system controller, similar to the controller 14, capable of processing the information about the environment 40 surrounding the vehicle 12. In an exemplary embodiment, the automated driving system 24 may operate in a manual operation mode, a partially automated operation mode, and a fully automated operation mode.

In the scope of the present disclosure, the manual operation mode means that the automated driving system 24 provides warnings or notifications to the vehicle occupant 44 but does not intervene or control the vehicle 12 directly. In a non-limiting example, the automated driving system 24 receives information from the plurality of vehicle sensors 16. Using techniques such as, for example, computer vision, the automated driving system 24 understands the environment 40 surrounding the vehicle 12 and provides assistance to the vehicle occupant 44. For example, if the automated driving system 24 identifies, based on data from the plurality of vehicle sensors 16, that the vehicle 12 is likely to collide with a remote vehicle, the automated driving system 24 may use the AR-HUD system 18, the TWD system 20, and/or the HMI 22 to provide a warning to the vehicle occupant 44.

In the scope of the present disclosure, the partially automated operation mode means that the automated driving system 24 provides warnings or notifications to the vehicle occupant 44 and may intervene or control the vehicle 12 directly in certain situations. In a non-limiting example, the automated driving system 24 is additionally in electrical communication with components of the vehicle 12 such as a brake system, a propulsion system, and/or a steering system of the vehicle 12, such that the automated driving system 24 may control the behavior of the vehicle 12. In a non-limiting example, the automated driving system 24 may control the behavior of the vehicle 12 by applying brakes of the vehicle 12 to avoid an imminent collision. In another non-limiting example, the automated driving system 24 may control the steering system of the vehicle 12 to provide an automated lane keeping feature. In another non-limiting example, the automated driving system 24 may control the brake system, propulsion system, and steering system of the vehicle 12 to temporarily drive the vehicle 12 towards a predetermined destination. However, intervention by the occupant may be required at any time. In an exemplary embodiment, the automated driving system 24 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 24 uses data from the plurality of vehicle sensors 16 to understand the environment 40 and control the vehicle 12 to drive the vehicle 12 to a predetermined destination without a need for control or intervention by the vehicle occupant 44.

The automated driving system 24 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the plurality of vehicle sensors 16. In another exemplary embodiment, the path planning algorithm is a deterministic algorithm which has been programmed to output control signals for the vehicle 12 based on data collected from the plurality of vehicle sensors 16.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 32 of the controller 14 and/or on a remote database or server.

In another exemplary embodiment, the path planning algorithm performs perception and mapping tasks to interpret data collected from the plurality of vehicle sensors 16 and create, update, and/or augment the detailed map. In a non-limiting example, the path planning algorithm constantly receives data about the environment 40 surrounding the vehicle 12 from the plurality of vehicle sensors 16 and interprets the data. In a non-limiting example, interpreting the data includes performing computer vision tasks such as, for example, segmentation, classification, localization, and/or the like of objects perceived by the plurality of vehicle sensors 16.

In an exemplary embodiment, a result of one or more of the computer vision tasks includes a perception confidence value. The perception confidence value indicates a confidence level in the interpretation of the data received from the plurality of vehicle sensors 16. The example, if an exemplary object perceived by the plurality of vehicle sensors 16 is classified as a tree by the computer vision tasks, the associated perception confidence value indicates a confidence that the exemplary object is in fact a tree. In a non-limiting example, a perception confidence value of one indicates a very high confidence, and a perception confidence value of zero includes a very low confidence.

As discussed above, the path planning algorithm is constantly receiving additional data about the environment 40 surrounding the vehicle 12 from the plurality of vehicle sensors 16. Accordingly, the path planning algorithm may adjust the sequence of waypoints or continuous path based on changing conditions in the environment 40 surrounding the vehicle 12. For example, changing and/or unexpected behavior of other road users (i.e., remote vehicle occupants), such as, for example, sudden stopping, turning, lane changes, and/or the like may result in adjustment to the sequence of waypoints or continuous path by the path planning algorithm.

In another example, incursion of foreign objects onto the roadway, such as, for example, unexpected pedestrians, wildlife, debris from a motor vehicle accident, and/or the like, may result in adjustment to the sequence of waypoints or continuous path by the path planning algorithm. An adjustment to the sequence of waypoints or continuous path is referred to herein as a “planned change in driving behavior”. Accordingly, in the scope of the present disclosure, a planned change in driving behavior is any adjustment to the sequence of waypoints or continuous path made by the path planning algorithm. In a non-limiting example, the planned change in driving behavior includes at least one of a sudden stop, a sudden acceleration, a lane change, and/or a lane merge.

It should be understood that the automated driving system 24 may include any software and/or hardware module configured to operate in the manual operation mode, the partially automated operation mode, or the fully automated operation mode as described above.

The haptic feedback device 26 is used to provide haptic feedback to the vehicle occupant 44. In the scope of the present disclosure, haptic feedback includes forces, vibrations, or motions provided to the vehicle occupant 44 to notify the vehicle occupant 44. In an exemplary embodiment, the haptic feedback device 26 includes one or more actuators disposed within the vehicle 12. In the scope of the present disclosure, the one or more actuators includes, for example, a linear resonant actuator (LRA), an eccentric rotating mass (ERM) actuator, and/or a piezoelectric actuator. In a non-limiting example, the one or more actuators are disposed within an element of the vehicle 12 with which the vehicle occupant 44 is in contact with while operating the vehicle 12, such as, for example, a seat of the vehicle 12, a steering wheel of the vehicle 12, and/or the like.

In a non-limiting example, one or more actuators may be located such that selective actuation of the one or more actuators provides the vehicle occupant 44 with additional information about the notification. For example, the one or more actuators may be located in multiple regions of the seat of the vehicle 12, such that haptic feedback may be created in the multiple regions of the seat through selective actuation of the one or more actuators. Accordingly, haptic feedback originating from each of the multiple regions of the seat may indicate various types of notifications to the vehicle occupant 44. The one or more actuators of the haptic feedback device 26 are in electrical communication with the controller 14 as discussed above.

The rear display 28 is used to provide information to remote vehicle occupants of remote vehicles behind the vehicle 12. In an exemplary embodiment, the rear display 28 is affixed to a rear windscreen 78 of the vehicle 12. In a non-limiting example, the rear display 28 is an electronic display such as, for example, a liquid-crystal display (LCD), a light-emitting diode (LED) display, a plasma display, an electroluminescent display, and/or the like. In another non-limiting example, the rear windscreen 78 includes transparent phosphors which are configured to emit light when selectively excited by a laser projector, similar to the TWD system 20 discussed above.

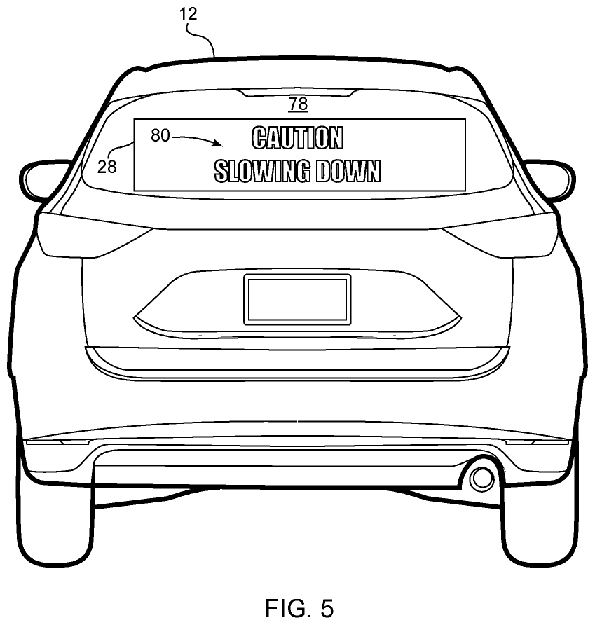

Referring to FIG. 5, a schematic diagram of an exemplary use of the rear display 28 is shown. As shown in FIG. 5, the rear display 28 may be used to provide information to remote vehicle occupants of remote vehicles behind the vehicle 12, such as, for example, a message 80. In a non-limiting example, the message 80 includes the text “CAUTION SLOWING DOWN” to inform the remote vehicle occupants that the vehicle 12 is decelerating. It should be understood that the rear display 28 may be used to display any message, graphic, image, icon and/or the like within the present disclosure. The rear display 28 may additionally adjust a color, size, and/or location of the message 80 within the scope of the present disclosure. The rear display 28 is in electrical communication with the controller 14 as discussed above.

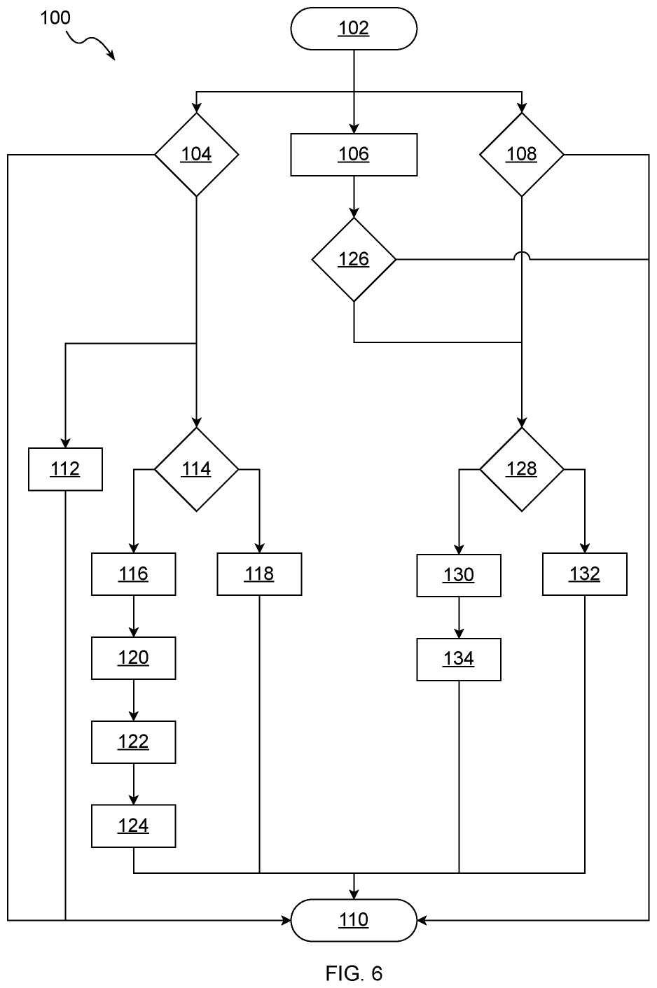

Referring to FIG. 6, a flowchart of the method 100 for providing information to the vehicle occupant 44 of the vehicle 12 is shown. The method 100 begins at block 102 and proceeds to blocks 104, 106, and 108.

At block 104, the controller 14 monitors the path planning algorithm of the automated driving system 24 for a planned change in driving behavior. As discussed above, the planned change in driving behavior is any adjustment to the sequence of waypoints or continuous path made by the path planning algorithm of the automated driving system 24, including a sudden stop, a sudden acceleration, a lane change, and/or a lane merge. If a planned change in driving behavior is not identified at block 104, the method 100 proceeds to enter a standby state at block 110. If a planned change in driving behavior is identified at block 104, the method 100 proceeds to blocks 112 and 114.

At block 112, the controller 14 uses the rear display 28 to display the message 80 to one or more remote vehicle occupants of one or more remote vehicles behind the vehicle 12. In an exemplary embodiment, the message 80 is configured to notify the one or more remote vehicle occupants of the one or more remote vehicles of the planned change in driving behavior identified at block 104. For example, if the planned change in driving behavior includes a sudden stop, the message 80 may state “CAUTION SLOWING DOWN” as shown in FIG. 5. It should be understood that the message 80 may include any text, graphic, image, icon and/or the like within the present disclosure. After block 112, the method 100 proceeds to enter the standby state at block 110.

At block 114, the controller 14 determines a notification modality. In the scope of the present disclosure the notification modality is a method by which the controller 14 will notify the vehicle occupant 44 about the planned change in driving behavior. In the scope of the present disclosure, the notification modality includes one of: a visual notification modality and a haptic notification modality, as will be discussed in greater detail below.

The notification modality is based at least in part on a gaze direction of the vehicle occupant 44. In the scope of the present disclosure, the gaze direction of the vehicle occupant 44 is a direction in which the vehicle occupant 44 is currently looking. In the scope of the present disclosure, the gaze direction includes one of: a front windscreen gaze direction (i.e., the vehicle occupant 44 is looking towards the front windscreen 42) and a non-front windscreen gaze direction (i.e., the vehicle occupant 44 is looking anywhere besides the front windscreen 42). In an exemplary embodiment, the occupant position tracking device 50 is used to determine an angle of the head 52a of the vehicle occupant 44, and the gaze direction is determined based at least in part on the angle of the head 52a of the vehicle occupant 44. In another exemplary embodiment, the occupant position tracking device 50 is used to perform eye tracking on the eyes 52b of the vehicle occupant 44, and the gaze direction is determined based at least in part on the eye tracking of the eyes 52b of the vehicle occupant 44. If the gaze direction is determined to be the front windscreen gaze direction, the method 100 proceeds to block 116. If the gaze direction is determined to be the non-front windscreen gaze direction, the method 100 proceeds to block 118.

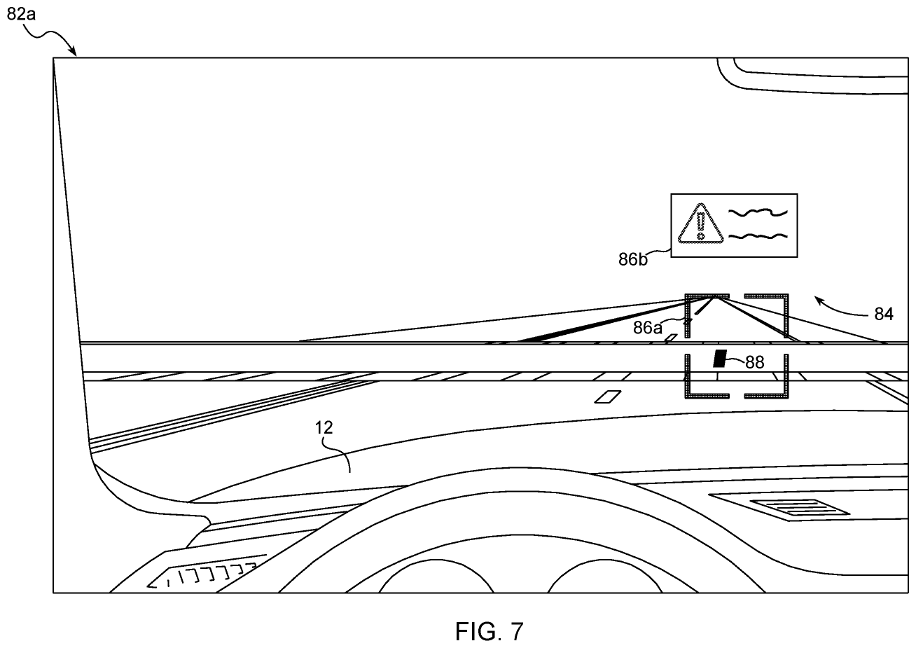

Referring to FIG. 7, a schematic diagram of a first view 82a from within the vehicle 12 from a perspective of the vehicle occupant 44 is shown. The first view 82a includes a warning graphic 84. The warning graphic 84 includes a warning location indicator 86a and a text warning 86b, as will be discussed in greater detail below. The warning location indicator 86a is positioned to highlight a foreign object 88 (e.g., a tire mark) on the roadway, as will be discussed in greater detail below. The warning graphic 84 may be displayed using the AR-HUD system 18, the TWD system 20, or a combination of both the AR-HUD system 18 and the TWD system 20. It should also be understood that the warning graphic 84 may be displayed on the HMI 22 without departing from the scope of the present disclosure.

Referring again to FIG. 6 with continued reference to FIG. 7, at block 116, the controller 14 determines an explanation for the planned change in driving behavior. In the scope of the present disclosure, the explanation is a reasoning behind the planned change in driving behavior. The explanation includes objects in the environment 40 which influenced the planned change in driving behavior. For example, in an exemplary scenario, the plurality of vehicle sensors 16 erroneously identifies the foreign object 88 upon the roadway as a pedestrian, and thus initiates the planned change in driving behavior (e.g., a sudden stop). Therefore, in the exemplary scenario, the explanation for the planned change in driving behavior is the perceived pedestrian.

The explanation further includes an explanation confidence value. The explanation confidence value indicates a confidence level in the reasoning behind the planned change in driving behavior. A high explanation confidence value (e.g., an explanation confidence value of one) indicates that the reasoning behind the planned change in driving behavior is likely to be correct.

In an exemplary embodiment, the explanation for the planned change in driving behavior is determined using an explainable artificial intelligence (XAI) algorithm. In an exemplary embodiment, the explainable artificial intelligence (XAI) algorithm is a machine learning algorithm used to provide human-understandable explanations for the decisions made by the path planning algorithm of the automated driving system 24. In a non-limiting example, the path planning algorithm of the automated driving system 24 is a deep learning algorithm (e.g., a neural network algorithm), and the XAI algorithm is applied to the path planning algorithm to determine the explanation for the planned change in driving behavior. The function of an exemplary XAI algorithm is discussed in greater detail in U.S. Publication No. U.S. Pat. No. 20,220,067511A1, titled “METHODS, SYSTEMS, AND APPARATUSES FOR USER-UNDERSTANDABLE EXPLAINABLE LEARNING MODELS”, filed on Sep. 17, 2020, the entire contents of which is hereby incorporated by reference.

In an exemplary embodiment, the explanation confidence value is determined based at least in part on the perception confidence value of the objects in the environment 40 which influenced the planned change in driving behavior. In another exemplary embodiment, the explanation confidence value is further determined based at least in part on an XAI confidence value produced by the XAI algorithm. After block 116, the method 100 proceeds to block 120.

At block 120, the controller 14 identifies an object of interest in the environment 40 surrounding the vehicle 12. In an exemplary embodiment, the object of interest is an object and/or region in the environment 40 which caused the automated driving system 24 to initiate the planned change in driving behavior. Thus, in the first view 82a shown in FIG. 7, the foreign object 88 is identified as the object of interest, because the explanation indicated that the foreign object 88 has been identified as a pedestrian, initiating the planned change in driving behavior.

It should be understood that in some examples, the object of interest may include a region of the environment 40 surrounding the vehicle 12, rather than a specific object like the foreign object 88. For example, the object which caused the automated driving system 24 to initiate the planned change in driving behavior may be in motion, and thus may leave a field of view of the vehicle occupant 44. In another example, the object which caused the automated driving system 24 to initiate the planned change in driving behavior may be a transitory condition, such as, for example, a shadow, a reflection, a glare, and/or the like. Therefore, in such examples, the object of interest is considered to be a region of the environment 40 surrounding the vehicle 12 including a last known location of the object which caused the automated driving system 24 to initiate the planned change in driving behavior. After block 120, the method 100 proceeds to block 122.

At block 122, the controller 14 generates the warning graphic 84. In an exemplary embodiment, the warning graphic 84 includes the warning location indicator 86a and the text warning 86b. The warning location indicator 86a appears, from a perspective of the vehicle occupant 44, to be overlayed on the object of interest (e.g., the foreign object 88), as shown in the first view 82a in FIG. 7. In an exemplary embodiment, at least one of a size, shape, and color of the warning location indicator 86a is used to visually indicate the explanation confidence value of the explanation. For example, if the explanation confidence value is less than or equal to 0.33, the warning location indicator 86a is colored red. If the explanation confidence value is greater than 0.33 and less than or equal to 0.66, the warning location indicator 86a is colored orange. If the explanation confidence value is greater than 0.66, the warning location indicator 86a is colored green.

In an exemplary embodiment, the text warning 86b includes the reasoning behind the planned change in driving behavior. For example, in the example shown in FIG. 7, the text warning 86b may include the text “Stopping because of perceived pedestrian in roadway”. Therefore, based on the text warning 86b and the location and color of the warning location indicator 86a, the vehicle occupant 44 may take action to disable and/or override the automated driving system 24, such as, for example, depressing an accelerator pedal of the vehicle 12. It should be understood that the appearance and composition of the warning graphic 84 discussed above and shown in FIG. 7 are merely exemplary in nature, and that any graphic configured to warn the vehicle occupant 44 and/or provide the reasoning behind the planned change in driving behavior to the vehicle occupant 44 is within the scope of the present disclosure. After block 122, the method 100 proceeds to block 124.

At block 124, the controller 14 uses at least one of the AR-HUD system 18, the TWD system 20, and the HMI 22 to display the warning graphic 84 to the vehicle occupant 44. To display the warning graphic 84, the controller 14 first determines the position of the vehicle occupant 44 using the occupant position tracking device 50, as discussed above. After determining the position of the vehicle occupant 44, the controller 14 calculates the size, shape, and location of the AR-HUD graphic 46 (i.e., the warning graphic 84) as discussed above. The location of the AR-HUD graphic 46 is chosen such that the warning location indicator 86a appears, from a perspective of the vehicle occupant 44, to be overlayed on the object of interest (e.g., the foreign object 88), as shown in the first view 82a in FIG. 7.

After calculating the size, shape, and location of the AR-HUD graphic 46 (i.e., the warning graphic 84), the controller 14 displays the AR-HUD graphic 46 using at least one of the AR-HUD system 18 and the TWD system 20, as discussed above. In an exemplary embodiment, the controller 14 additionally uses the HMI 22 to provide an augmented view of the environment 40 surrounding the vehicle 12 including the AR-HUD graphic 46. After block 124, the method 100 proceeds to enter the standby state at block 110.

At block 118, the controller 14 uses the haptic feedback device 26 to provide haptic feedback to the vehicle occupant 44 notifying the vehicle occupant 44 about the planned change in driving behavior. In an exemplary embodiment, at block 118, the controller 14 also determines the explanation for the planned change in driving behavior as discussed above in reference to block 116. In a non-limiting example, one or more aspects of the haptic feedback, such as, for example, an intensity, a location, a duration, and/or the like are adjusted based at least in part on the explanation, such as, for example, based on the explanation confidence value. After block 118, the method 100 proceeds to enter the standby state at block 110.

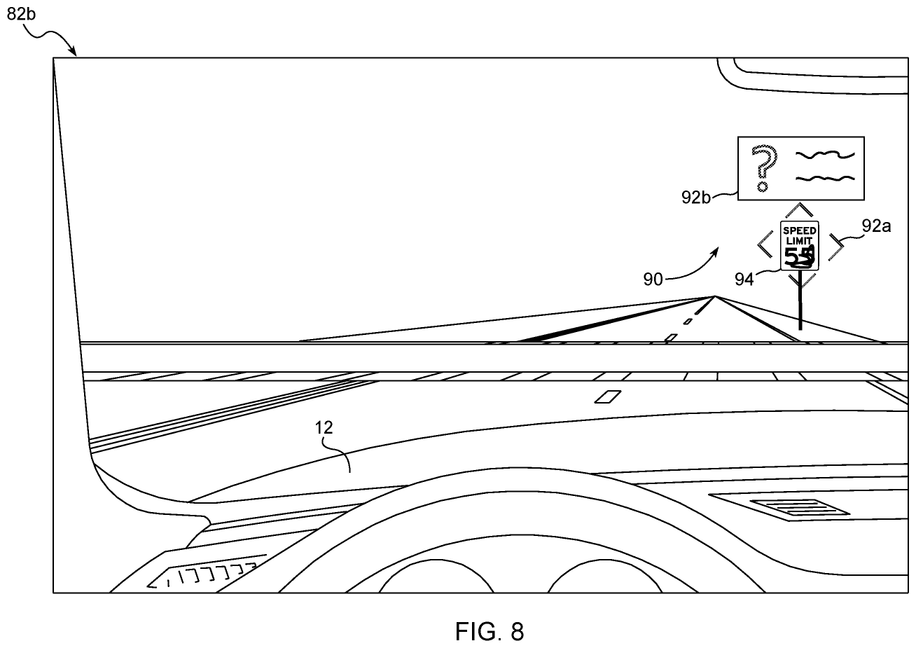

Referring to FIG. 8, a schematic diagram of a second view 82b from within the vehicle 12 from a perspective of the vehicle occupant 44 is shown. The second view 82b includes a confirmation graphic 90. The confirmation graphic 90 includes a sign location indicator 92a and a text confirmation message 92b, as will be discussed in greater detail below. The sign location indicator 92a is positioned to highlight a traffic sign of interest 94 near the roadway, as will be discussed in greater detail below. As shown in FIG. 8, the traffic sign of interest 94 is partially obstructed. The confirmation graphic 90 may be displayed using the AR-HUD system 18, the TWD system 20, or a combination of both the AR-HUD system 18 and the TWD system 20. It should also be understood that the confirmation graphic 90 may be displayed on the HMI 22 without departing from the scope of the present disclosure.

Referring again to FIG. 6 with continued reference to FIG. 8, at block 106, the controller 14 uses the plurality of vehicle sensors 16 to detect the traffic sign of interest 94. In the scope of the present disclosure, the traffic sign of interest 94 includes any traffic sign in the environment 40 surrounding the vehicle 12. After detecting the traffic sign of interest 94, the controller 14 uses the plurality of vehicle sensors 16 to identify the traffic sign of interest. For example, the traffic sign of interest 94 may be identified as a speed limit sign.

In the example shown in the second view 82b in FIG. 8, the traffic sign of interest 94 is obstructed, and therefore may be identified as a speed limit sign with a speed limit of five miles per hour. After block 106, the method 100 proceeds to block 126.

At block 126, the controller 14 searches a database of known traffic signs for the traffic sign of interest 94. In an exemplary embodiment, the database of known traffic signs is stored in the media 32 of the controller 14. In another exemplary embodiment, the database of known traffic signs is stored on a remote server system and accessed using the vehicle communication system 36. If the traffic sign of interest 94 is found in the database, the method 100 proceeds to enter the standby state at block 110. In the example shown in the second view 82b in FIG. 8, the traffic sign of interest 94 is not found in the database, because five miles per hour is not a valid type of speed limit sign stored in the database. If the traffic sign of interest 94 is not found in the database, a traffic sign interpretation error is determined to have been identified, and the method 100 proceeds to block 128, as will be discussed in greater detail below.

In the scope of the present disclosure, a traffic sign interpretation error is any failure of the plurality of vehicle sensors 16 and/or the automated driving system 24 to interpret a traffic sign. For example, if a traffic sign is obstructed, dirty, vandalized, damaged, or otherwise defective, the plurality of vehicle sensors 16 and/or the automated driving system 24 may fail to interpret the traffic sign, resulting in a traffic sign interpretation error. Additionally, a missing traffic sign may also result in a traffic sign interpretation error. For example, if the vehicle 12 approaches a four-way intersection with no visible and/or interpretable traffic signs, the controller 14 may identify a traffic sign interpretation error.

At block 108, the controller 14 uses the plurality of vehicle sensors 16 and the automated driving system 24 to monitor the environment 40 surrounding the vehicle 12 for a missing traffic sign. If the environment 40 is identified to be missing a traffic sign, for example, if the environment 40 contains features such as intersections, junctions, ending lanes, narrowing lanes, and/or the like, without proper traffic signs identifying these features, a traffic sign interpretation error is identified and the method 100 proceeds to block 128. If the environment 40 is not found to be missing a traffic sign, the method 100 proceeds to enter the standby state at block 110.

At block 128, the controller 14 determines a notification modality. The notification modality is based at least in part on a gaze direction of the vehicle occupant 44. In an exemplary embodiment, the occupant position tracking device 50 is used to determine an angle of the head 52a of the vehicle occupant 44, and the gaze direction is determined based at least in part on the angle of the head 52a of the vehicle occupant 44. In another exemplary embodiment, the occupant position tracking device 50 is used to perform eye tracking on the eyes 52b of the vehicle occupant 44, and the gaze direction is determined based at least in part on the eye tracking of the eyes 52b of the vehicle occupant 44. If the gaze direction is determined to be the front windscreen gaze direction, the method 100 proceeds to block 130. If the gaze direction is determined to be the non-front windscreen gaze direction, the method 100 proceeds to block 132.

Referring to FIG. 8 and with continued reference to FIG. 6, at block 130, the controller 14 generates the confirmation graphic 90, as discussed above. The confirmation graphic 90 includes the sign location indicator 92a and the text confirmation message 92b. The sign location indicator 92a is positioned to highlight the traffic sign of interest 94. If the environment 40 is identified to be missing a traffic sign, as discussed above in reference to block 108, the sign location indicator 92a may be omitted from the confirmation graphic 90. The text confirmation message 92b is configured to prompt the vehicle occupant 44 to resolve the traffic sign interpretation error. In an exemplary embodiment, the text confirmation message 92b includes a message such as, for example, “Speed limit interpreted as 5 MPH, is this correct?” or “Missing traffic sign, please state proper action”.

In an exemplary embodiment, the vehicle occupant 44 resolves the traffic sign interpretation error by providing additional information and/or confirmation to the vehicle 12 using, for example, voice commands received by a microphone, gesture commands received by an interior camera, interaction with a physical button and/or the HMI 22, and/or the like. In another exemplary embodiment, the automated driving system 24 is configured to resolve the traffic sign interpretation error using an error-handing algorithm (e.g., a machine learning algorithm). After block 130, the method 100 proceeds to block 134.

At block 134, the controller 14 uses at least one of the AR-HUD system 18, the TWD system 20, and the HMI 22 to display the confirmation graphic 90 to the vehicle occupant 44. To display the confirmation graphic 90, the controller 14 first determines the position of the vehicle occupant 44 using the occupant position tracking device 50, as discussed above. After determining the position of the vehicle occupant 44, the controller 14 calculates the size, shape, and location of the AR-HUD graphic 46 (i.e., the confirmation graphic 90) as discussed above. In some examples, as discussed above, the location of the AR-HUD graphic 46 is chosen such that the sign location indicator 92a appears, from a perspective of the vehicle occupant 44, to be overlayed on the traffic sign of interest 94, as shown in the second view 82b in FIG. 8.

After calculating the size, shape, and location of the AR-HUD graphic 46 (i.e., the confirmation graphic 90), the controller 14 displays the AR-HUD graphic 46 using at least one of the AR-HUD system 18 and the TWD system 20, as discussed above. In an exemplary embodiment, the controller 14 additionally uses the HMI 22 to provide an augmented view of the environment 40 surrounding the vehicle 12 including the AR-HUD graphic 46. After block 134, the method 100 proceeds to enter the standby state at block 110.

At block 132, the controller 14 uses the haptic feedback device 26 to provide haptic feedback to the vehicle occupant 44 notifying the vehicle occupant 44 about the traffic sign interpretation error. In a non-limiting example, one or more aspects of the haptic feedback, such as, for example, an intensity, a location, a duration, and/or the like are adjusted based at least in part on the traffic sign interpretation error, such as, for example, based on a nature of the traffic sign interpretation error (i.e., an obstructed traffic sign vs. a missing traffic sign). After block 132, the method 100 proceeds to enter the standby state at block 110.

In an exemplary embodiment, the controller 14 repeatedly exits the standby state 110 and restarts the method 100 at block 102. In a non-limiting example, the controller 14 exits the standby state 110 and restarts the method 100 on a timer, for example, every three hundred milliseconds.

The system 10 and method 100 of the present disclosure offer several advantages. By providing warning notifications and/or haptic feedback to the vehicle occupant 44 about planned changes in driving behavior, the system 10 increases occupant awareness, allowing the vehicle occupant 44 an opportunity to correct or prevent the planned change in driving behavior. Using XAI, the vehicle occupant 44 is provided with a reasoning behind the planned change in driving behavior, enabling the vehicle occupant 44 to evaluate whether to intervene to correct or prevent the planned change in driving behavior. By providing notifications to the remote vehicle occupant using the rear display 28, the remote vehicle occupant is informed about planned changes in driving behavior, increasing the awareness of the remote vehicle occupant. By providing confirmation notifications to the vehicle occupant 44 about traffic sign interpretation errors, the vehicle occupant 44 may provide additional information to the automated driving system 18, improving an operation of the automated driving system 18.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for providing information to a vehicle occupant of a vehicle, the system comprising:
an automated driving system;
a first display configured to provide information to the vehicle occupant of the vehicle; and
a controller in electrical communication with the automated driving system and the first display, wherein the controller is programmed to:
identify a planned change in driving behavior initiated by the automated driving system;
identify a traffic sign interpretation error using the automated driving system; and
notify the vehicle occupant using the first display in response to identifying at least one of: the planned change in driving behavior and the traffic sign interpretation error.

2. The system of claim 1, wherein to identify the planned change in driving behavior, the controller is further programmed to:
monitor a path planning algorithm of the automated driving system for the planned change in driving behavior, wherein the planned change in driving behavior includes at least one of: a sudden stop, a sudden acceleration, a lane change, and a lane merge.

3. The system of claim 1, further comprising a plurality of vehicle sensors in electrical communication with the controller, wherein to identify the traffic sign interpretation error, the controller is further programmed to:
detect a traffic sign of interest using the plurality of vehicle sensors;
search a database of known traffic signs for the traffic sign of interest; and
identify the traffic sign interpretation error in response to determining that the traffic sign of interest is not found within the database of known traffic signs.

4. The system of claim 1, wherein to notify the vehicle occupant, the controller is further programmed to:
generate a graphic based at least in part on at least one of: the planned change in driving behavior and the traffic sign interpretation error; and
display the graphic to the vehicle occupant using the first display.

5. The system of claim 4, wherein to generate the graphic, the controller is further programmed to:
generate a warning graphic in response to identifying the planned change in driving behavior, wherein the warning graphic is configured to warn the vehicle occupant of the planned change in driving behavior; and
generate a confirmation graphic in response to identifying the traffic sign interpretation error, wherein the confirmation graphic is configured to prompt the vehicle occupant to resolve the traffic sign interpretation error.

6. The system of claim 5, wherein to generate the warning graphic, the controller is further programmed to:
determine an explanation for the planned change in driving behavior using an explainable artificial intelligence (XAI) algorithm;
identify an object of interest in an environment surrounding the vehicle which caused the automated driving system to initiate the planned change in driving behavior based at least in part on the explanation; and
generate the warning graphic, wherein the warning graphic appears overlayed on the object of interest from a perspective of the vehicle occupant.

7. The system of claim 4, wherein the first display is an augmented reality head-up display (AR-HUD) system in electrical communication with the controller, wherein the AR-HUD system includes an occupant position tracking device and an AR-HUD projector, and wherein to display the graphic, the controller is further programmed to:
determine a position of the vehicle occupant of the vehicle using the occupant position tracking device;
calculate a size, shape, and location of the graphic based on the position of the vehicle occupant; and
display the graphic on a front windscreen of the vehicle using the augmented reality head up display system based on the size, shape, and location.

8. The system of claim 7, wherein the first display further includes a transparent front windscreen display (TWD) system in electrical communication with the controller, wherein the transparent front windscreen display system includes transparent phosphors embedded in the front windscreen of the vehicle and a TWD projector, and wherein to display the graphic, the controller is further programmed to:
calculate a size, shape, and location of the graphic; and
display the graphic on the front windscreen of the vehicle using the TWD system based on the size, shape, and location.

9. The system of claim 1, further comprising a second display in electrical communication with the controller, wherein the second display is configured to provide information to a remote vehicle occupant, and wherein the controller is further programmed to:
notify the remote vehicle occupant using the second display in response to identifying the planned change in driving behavior.

10. The system of claim 1, further comprising a haptic feedback device in electrical communication with the controller, and wherein the controller is further programmed to:
notify the vehicle occupant using the haptic feedback device in response to identifying the planned change in driving behavior.

11. A method for providing information to a vehicle occupant of a vehicle, the method comprising:
identifying a planned change in driving behavior initiated by an automated driving system;
identifying a traffic sign interpretation error using the automated driving system;
determining a notification modality in response to identifying at least one of: the planned change in driving behavior and the traffic sign interpretation error, wherein the notification modality includes one of: a visual notification modality and a haptic notification modality;
notifying the vehicle occupant using an augmented reality head-up display (AR-HUD) system in response to determining that the notification modality is the visual notification modality; and
notifying the vehicle occupant using a haptic feedback device in response to determining that the notification modality is the haptic notification modality.

12. The method of claim 11, wherein identifying the planned change in driving behavior further comprises:
monitoring a path planning algorithm of the automated driving system for the planned change in driving behavior, wherein the planned change in driving behavior includes at least one of: a sudden stop, a sudden acceleration, a lane change, and a lane merge.

13. The method of claim 11, wherein identifying the traffic sign interpretation error further comprises:
detecting a traffic sign of interest using a plurality of vehicle sensors;
searching a database of known traffic signs for the traffic sign of interest; and
identifying the traffic sign interpretation error in response to determining that the traffic sign of interest is not found within the database of known traffic signs.

14. The method of claim 11, wherein determining the notification modality further comprises:
determining a gaze direction of the vehicle occupant using an occupant position tracking device, wherein the gaze direction includes: a front windscreen gaze direction and a non-front windscreen gaze direction;
determining the notification modality to be the visual notification modality in response to determining that the gaze direction is the front windscreen gaze direction; and
determining the notification modality to be the haptic notification modality in response to determining that the gaze direction is the non-front windscreen gaze direction.

15. The method of claim 11, wherein notifying the vehicle occupant using the AR-HUD system further comprises:
generating a warning graphic in response to identifying the planned change in driving behavior, wherein generating the warning graphic further comprises:
determining an explanation for the planned change in driving behavior using an explainable artificial intelligence (XAI) algorithm;
identifying an object of interest in an environment surrounding the vehicle which caused the automated driving system to initiate the planned change in driving behavior based at least in part on the explanation; and
generating the warning graphic, wherein the warning graphic appears overlayed on the object of interest from a perspective of the vehicle occupant; and
generating a confirmation graphic in response to identifying the traffic sign interpretation error, wherein the confirmation graphic is configured to prompt the vehicle occupant to resolve the traffic sign interpretation error.

16. The method of claim 15, wherein notifying the vehicle occupant using the AR-HUD system further comprises:
determining a position of the vehicle occupant of the vehicle using an occupant position tracking device;
calculating a size, shape, and location of the warning graphic based on the position of the vehicle occupant; and
displaying at least one of the warning graphic and the confirmation graphic on a front windscreen of the vehicle using the AR-HUD system based on the size, shape, and location.

17. The method of claim 11, further comprising:
notifying a remote vehicle occupant using a second display in response to identifying the planned change in driving behavior, wherein the second display is configured to provide information to the remote vehicle occupant.

18. A system for providing information to a vehicle occupant of a vehicle, the system comprising:
a plurality of vehicle sensors;
an automated driving system;
a first display configured to provide information to the vehicle occupant of the vehicle;
a second display configured to provide information to a remote vehicle occupant of a remote vehicle, wherein the second display is a rear display affixed to a rear windscreen of the vehicle;
a controller in electrical communication with the plurality of vehicle sensors, the automated driving system, the first display and the second display, wherein the controller is programmed to:
identify a planned change in driving behavior initiated by the automated driving system;
identify a traffic sign interpretation error using the automated driving system;
notify the vehicle occupant using the first display in response to identifying at least one of: the planned change in driving behavior and the traffic sign interpretation error; and
notify the remote vehicle occupant using the second display in response to identifying the planned change in driving behavior.

19. The system of claim 18, wherein to notify the vehicle occupant using the first display, the controller is further programmed to:
determine an explanation for the planned change in driving behavior using an explainable artificial intelligence (XAI) algorithm;
identify an object of interest in an environment surrounding the vehicle which caused the automated driving system to initiate the planned change in driving behavior based at least in part on the explanation;
generate a warning graphic, wherein the warning graphic indicates the object of interest; and
display the warning graphic to the vehicle occupant using the first display.

20. The system of claim 19, wherein the first display is an augmented reality head-up display (AR-HUD) system in electrical communication with the controller, wherein the AR-HUD system includes an occupant position tracking device and an AR-HUD projector, and wherein to display the warning graphic, the controller is further programmed to:
determine a position of the vehicle occupant of the vehicle using the occupant position tracking device;
calculate a size, shape, and location of the warning graphic based on the position of the vehicle occupant; and
display the warning graphic on a front windscreen of the vehicle using the augmented reality head up display system based on the size, shape, and location.
